(19) United States
(12) Patent Application Publication
(10) Pub. No.: US 2012/0250529 A1
(43) Pub. Date: Oct. 4, 2012

(54) MOBILE AD-HOC RE-ROUTING METHOD

(76) Inventors: John Lee, Howell, NJ (US); Subir Das, Belle Mead, NJ (US); Anthony J. McAuley, Glen Ridge, NJ (US)

(21) Appl. No.: 12/788,418

(22) Filed: May 27, 2010

Related U.S. Application Data
(60) Provisional application No. 61/297,107, filed on Jan. 21, 2010.

(51) Int. Cl. H04W 36/00; H04W 24/00; H04L 12/28

(52) U.S. Cl. 370/252; 370/331; 370/254; 370/255

(57) ABSTRACT

In a mobile ad-hoc re-routing system in which network nodes are identified by topology dissemination messages, including local “Hello” and global Topographical Control (“TC”) messages, the improvement comprises triggering topology dissemination messages based on at least one of a new neighbor determination and link loss determinations.

### CROSS REFERENCE TO RELATED APPLICATION

This application claims the benefit of the filing date of U.S. Provisional Application No. 61/297,107, filed on Jan. 21, 2010, the disclosures of which are incorporated herein by reference.

### STATEMENT REGARDING FEDERALLY SPONSORED RESEARCH OR DEVELOPMENT

Funding for research was made with Government support under W15P7T-08-C-B405 awarded by the US Army CERDEC. The Government has certain rights to this invention.

### BACKGROUND

1. Technical Field

The present invention relates to the field of ad-hoc network protocols and control architectures.

2. Description of the Related Art

In mobile ad-hoc network environments where nodes dynamically move, outdated routing paths may remain for some duration because most ad-hoc routing protocols (which are usually implemented at the network layer) are not promptly responsive to the node mobility. Consequently, packet loss takes place until the routing path is updated—packets are dropped during their transit from the source to the destination node. Accordingly, the traffic flow can get disrupted for a long period of time and the application associated with the flow can suffer degraded performance.

In the ad-hoc routing protocols such as Optimized Link State Routing (“OLSR”), a polling-trigger type of mechanism is employed to detect node mobility and invoke routing convergence. In the polling-trigger mechanism used in OLSR, every node periodically broadcasts information about the link connections to its neighbors, and based on these received periodic advertisements, nodes detect the mobility of their neighbors and update their routing tables. As an example, OLSR “Hello” messages may be broadcast at intervals of one second, and OLSR Topology Control (“TC”) messages may be broadcast at intervals of three seconds. To more promptly detect node mobility and invoke the routing convergence operation, the interval of periodic advertisement messages, such as the Hello and TC messages in OLSR, needs to be reduced. If such an interval is short (e.g., in the 100-millisecond range), node mobility can be detected faster and, in turn, the operation for the routing convergence can be triggered promptly. However, this approach results in higher control overhead—it consumes significant network resources by creating a high volume of periodic traffics on the network, especially when network density is high.

IEEE Media Independent Handover (“MIH”) services are used to improve the handover performance for infrastructure-based networks. In an infrastructure network environment, a mobile node can detect and maintain its access point(s) (i.e., base station for cellular networks) through periodic beacon messages from the access point(s). Through the periodic beacon messages, a mobile node can also maintain the receiving power level for its access point(s) by measuring the power levels of those received beacons. Based on such a measured receiving power level available through beacon messages, the MIH Function (“MIHF”) of an infrastructure network can provide feedback or hints to help make a handover decision. IEEE 802.21 MIH services are designed to optimize the handover for infrastructure-based networks. (See “The Network Simulator NS-2 NIST add-on IEEE 802.21 model,” NIST January 2007.)

A mechanism to obtain and maintain the receiving power level through beacon messages, which is feasible for infrastructure networks, is, however, not feasible for ad-hoc network environments because there are no periodic beacon messages. From MIH perspectives for the ad-hoc network environments, an ad-hoc node must consider each of its one-hop neighbors equivalent to an access point. It needs to obtain and maintain the status of the links (including the receiving power level) to all the neighbors. Therefore, the MIHF implementation needs to be enhanced for ad-hoc network environments so that the MIHF of an ad-hoc node can obtain and maintain the receiving power levels for the one-hop neighboring nodes.

MIHF framework implementation has been integrated with a mobility protocol, such as Mobile Internet Protocol (“MIP”) to minimize traffic disruption during handoff for an infrastructure network environment (See “The Network Simulator NS-2 NIST add-on IEEE802.21 model,” NIST January 2007). However, a MIHF framework for optimizing the performances of ad-hoc routing protocols for ad-hoc network environments has not been addressed so far.

### SUMMARY OF THE INVENTION

The present invention introduces several methods (or embodiments) which are required to realize a MIHF framework for ad-hoc routing protocols. In implementation perspectives, the MIH integration with an ad-hoc routing protocol such as OLSR is different than the NIST's MIH integration with MIP. For the MIH integration with MIP, only the end nodes running MIP are interfaced with their MIHFs; other nodes do not need to run MIHF However, for the MIH integration with routing, not only end nodes but also the intermediate nodes (Le., routers) must run MIHF. Since many nodes can be involved in routing convergence depending upon the topology, the MIHF and ad-hoc routing protocol needs to run on all nodes in the network. The MIHF configuration and feedback may also be different to provide the hints for handover in consideration of the routing parameters and behaviors as changes occur in network topology.

An objective of the present invention is to provide a MIH framework for ad-hoc routing protocols and to capture the effectiveness of MIH on ad-hoc network environments as well.

A mobile ad-hoc re-routing method, in which neighboring nodes are identified by “Hello” messages and routing convergence is dependent on Topographical Control (“TC”) messages, is improved by triggering at least one of the Hello messages and the TC messages based on at least one of a new neighbor determination and link loss determination. Preferably, the triggering is of Hello messages based on a determination of the strength of received radio signals between nodes indicating the appearance of a new neighbor or the triggering is of TC messages based on a link loss determination, or both.

The Hello and TC messages may be executed as a part of an Optimized Link State Routing (“OLSR”) protocol, the determination of the strength of received radio signals may be based on physical layer parameters, and the physical layer parameters may include at least one of radio model, radio frequency, transmitting power, and distance between sending and receiving nodes.

In a preferred embodiment, the at least one of a new neighbor determination and link loss determinations is communicated to the OLSR by a Media Independent Handover Function (“MIHF”).

In other words, there is provided a method of triggering a message being executed by a processor in a mobile ad-hoc re-routing system, the method comprising:
performing at least one of a new neighbor determination and a link loss determination in the mobile ad-hoc re-routing system; and triggering a message based on the at least one new neighbor determination and the link loss determination, wherein the triggered is message is a Hello message used to identify the neighboring nodes when the new neighbor determination is performed, and the triggered message is a Topographical Control (“TC”) message used for routing convergence when the link loss determination is performed.

### BRIEF DESCRIPTION OF THE DRAWINGS

The accompanying drawings, which are incorporated in and constitute a part of this specification, illustrate various embodiments. In the drawings:

FIG. 1 illustrates a static network configuration;

FIG. 2 illustrates the relationship between physical, MIHF, and OLSR operations in a network;

FIG. 3 illustrates a first network scenario (“Scenario 1”);

FIG. 4 illustrates a second network scenario (“Scenario 2”);

FIG. 5 shows simulation Packet Drop results of a first approach (“Approach 1”) as applied to Scenario 1;

FIG. 6 shows simulated Packet Drop results of Approach 1 and a second approach (“Approach 2”) as applied to Scenario 2;

FIG. 7 shows simulated performance comparison looking at both packet drop rate and control overhead for Scenario 1;

FIG. 8 shows simulated performance comparison looking at both packet drop rate and control overhead for Scenario 2; and

FIG. 9 shows simulated performance results for several OLSR Hello rate parameters, with a performance tradeoff between disconnection time and overhead with a without MIH.

### DESCRIPTION OF THE EMBODIMENTS

In the following description, for purposes of explanation and not limitation, specific techniques and embodiments are set forth, such as particular sequences of steps, interfaces, and configurations, in order to provide a thorough understanding of the techniques presented here. While the techniques and embodiments will primarily be described in the context of the accompanying drawings, those skilled in the art will further appreciate that the techniques and embodiments can also be practiced in other electronic devices or systems.

Reference will now be made in detail to exemplary embodiments of the present invention, examples of which are illustrated in the accompanying drawings. Whenever possible, the same reference numbers will be used throughout the drawings to refer to the same or like parts.

The present invention introduces a MIH framework for ad-hoc routing protocols for ad-hoc network environments. For realizing such a framework, MIHF collects underlying lower layers information such as received power and link loss determinations, and provides MIH information derived from this lower layer information to ad-hoc routing protocols. The routing protocol uses the MIH information to control the triggering of operational events such as Hello and/or TC messages in OLSR. Rather than having these messages always transmitted at regular period intervals, by using MIH received power and link loss determination, these same messages can be triggered and hence transmitted in a more efficient manner. These events thereby provide lower layer information, which can be categorized as lower or cross layer information, that become the source of interrupt-triggered Hello and TC messages and related routing convergence operations.

Thus, instead of the polling-trigger with high control overhead, the present invention uses an interruptive-trigger that does not depend on periodic detection messages, but rather uses the underlying lower layer information, such as received signal power and radio link status, without generating disruptive control overhead.

In order to realize the interruptive-trigger approach, the invention leverages the services of IEEE 802.21 MIHF for obtaining the necessary information from the underlying lower layers, and integrates these services from MIHF into the OLSR protocol. Based on the services received from MIHF, the OLSR protocol invokes triggering events such as Repeated Hello, TC upon Link_Down, and TC upon new neighbor.

In addition, in the interrupted-trigger process of the present invention, the sequence of triggers for routing convergence operations become important factors for the improvement of performance. According to the simulation results, the sequence of injecting additional repeated Hello messages upon new neighbor determination, sending an additional TC message upon new neighbor determination and sending an additional TC message upon Link_Down achieved good performances for the OLSR routing protocol during mobility.

The inventors used the OLSR model from the University of Murcia (“UM”) in Spain and updated it to work with MIH. UM-OLSR complies with RFC 3626 (see T. Clausen and P. Jacquet, Optimized Link State Routing Protocol (OLSR), RFC 3626, October 2003) and supports all core functionalities of OLSR. Without the need of recompiling the whole simulator, a debug mode can be activated or deactivated, and the intervals of control messages are configurable.

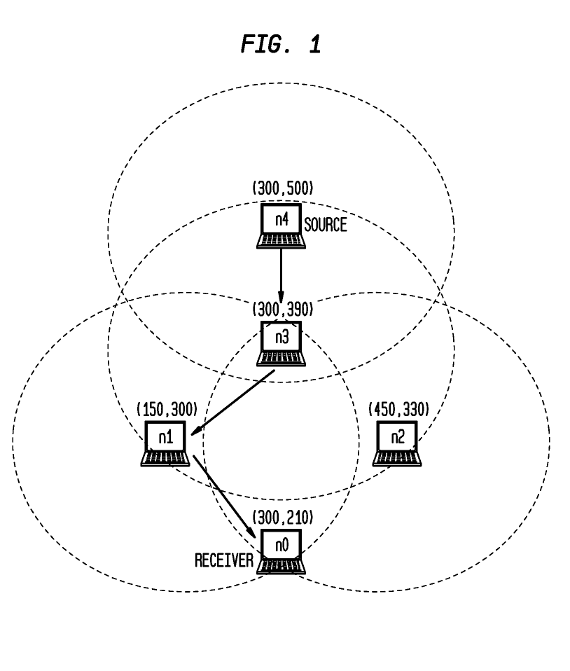

In order to verify the operations of UM-OLSR, the inventors created a simple simulation network with a static topology as shown in FIG. 1: Simple Network for OLSR operations and test for packet delivery. For the simulation, the radio range is about 200 meters, the packet size is 1000 bytes, the data rate is 10 packets per second, the OLSR Hello interval is 1 second, and the OLSR Topology Control (“TC”) interval is 3 seconds. The duration of the simulation is 100 seconds. The source n4 starts sending packets at the simulation time 10 seconds after the routing convergence of the simulation network. The receiver n0 has received all 600 packets without any packet loss. In addition, for routing consistency, the routing table of each and every node is verified.

The invention was first implemented in an IEEE 802.21 standard framework on ad-hoc network environments based on the National Institute of Science and Technology (“NIST”) NS-2 models that were designed for infrastructure-based networks.

According to the invention, either or both of two triggers improve the OLSR performance using the capabilities of MIHF: (1) trigger OLSR to invoke repeated “Hello” messages when the MIH agent detects a new neighbor is approaching by detecting radio signal power received from that neighbor as approaching the level needed to establish an actual link; and (2) in addition, trigger OLSR to remove or add a link and send a “TC update” message when the MIH agent of a node detects a Link_Going_Down event or a new neighbor respectively.

With these approaches, the Hello messages are sent less often than might be expected by the conventional approach of simply sending Hello messages more frequently, but when triggered the Hello messages are preferably sent in a more rapid succession, thereby engaging the new link more quickly than would be the case with a conventional sequence, but avoiding increased overhead by reducing the times that Hello messages are sent at all to those times when they are most likely needed to form a new link.

Moreover, by sending a TC link update message when an MIH event detects a loss of link or a new link, rather than relying on the next scheduled periodic TC message, link lists are more rapidly and effectively updated in other routers in the networks.

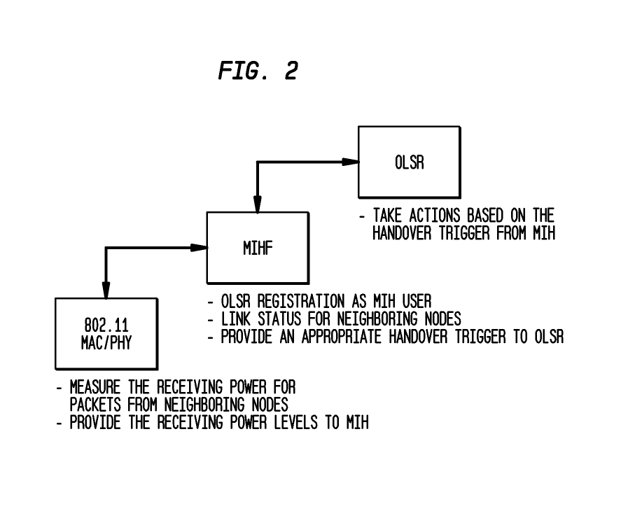

For the ad-hoc network environments, the MIHF of an ad-hoc node detects new links and maintains the status of the links with respect to the neighboring nodes. This is realized through the medium access control (“MAC”)/physical (“PHY”) layers, as shown in FIG. 2. The received signal power of each packet may be estimated based on the PHY layer parameters, such as the radio model, radiofrequency, transmitting power, and the distance between the sender and the receiver of the packet, both in actual implementation and in NS-2 simulation. When the radio parameters pass some configured threshold, the information about this estimated signal power along with the sender address (either MAC or IP address) is passed to the MIHF. When the OLSR receives the trigger and identifies the MIH event as a detection of a new neighbor with sufficient received signal power approaching or exceeding that needed to sustain a link, Hello messages are initiated to identify that new neighbor. When the OLSR receives the trigger and identifies the MIH event as a link loss event, appropriate TC messages are initiated to update link lists in relevant neighbors.

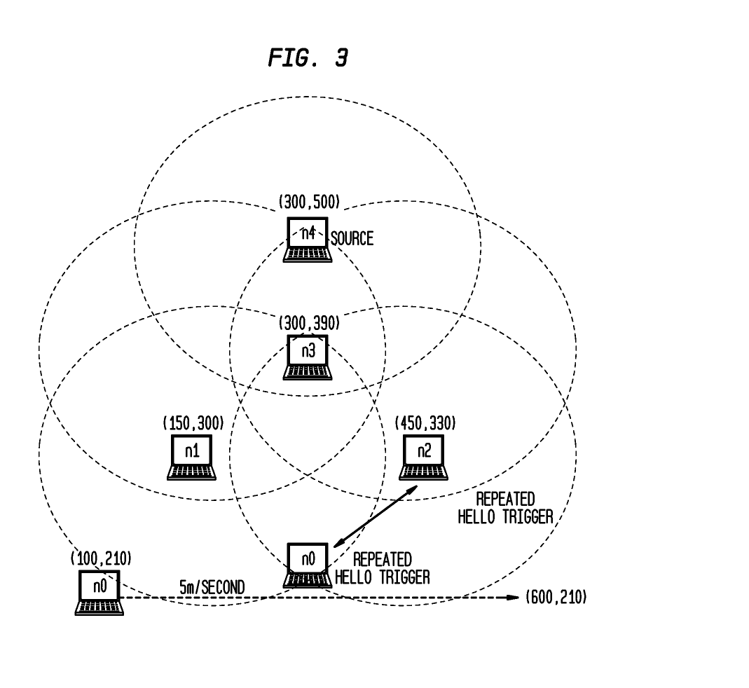

The first approach (“Approach 1”) (applied to a first network scenario (“Scenario 1”) shown in FIG. 3 as providing two possible two-hop paths between a source node and a receiver node) invokes repeated Hello triggers. In Scenario 1, the source n4 sends packets to the receiver n0, which is moving along the horizontal line that allows it to connect to n1 for the initial part of its path and to n2 for the latter part of its path. When n0 is within the coverage of only n1, the packets are delivered to n0 through the forwarding nodes n3 and n1. When n3 receives the packets destined to n0, according to its current routing table, it forwards the packets to n1, which is the next routing hop for the packets. On the other hand, once n0 moves into the coverage area of only n2, the existing routing entries for n0 at both n2 and n3 must be updated so that n3 can forward the packets to n2 rather than n1. In this network (shown in FIG. 3), routing convergence is realized through the exchange of the “Hello” messages between n0 and n2 for establishing a symmetric link between them, and the “Hello” message from n2 after establishing the symmetric link, which causes the routing update at n3.

In Approach 1, applied by way of example only to Scenario 1 of FIG. 3, TC messages are not involved to update the routing tables on the path from a source to the destination node; routing convergence against a topology change that requires routing update at the nodes only within the two-hop distance can be achieved through two consecutive Hello messages (only if these Hello messages have not experienced packet loss due to collision or channel condition). The convergence time in such cases is short since the Hello interval is usually shorter than the TC interval (e.g., 1 second versus 3 seconds). Note that if the overlapping area (i.e., the coverage of both n1 and n2) is large enough so that the symmetric link between n0 and n1 can be established while moving in the overlapping area, the nodes will not experience packet loss. Also note that TC messages are still required for the routing convergence of larger networks.

In Approach 1, the MIH agent (i.e., MIHF) of a node generates a trigger to the OLSR agent to invoke repeated “Hello” messages (i.e., Hello trigger) when the MIH agent detects a new neighbor (i.e., new link detection) or when the MIH agents of n0 and n2 detect that their receiving power levels for packets received from each other approaches becomes greater than a predefined receiving power level necessary to sustain the link. In either event, they trigger their OLSR agents to invoke Hello messages. Since the channel condition for the newly establishing link may not be reliable yet due to the radio coverage, and there is also a chance of the collision between Hello messages and data packets (due to a hidden terminal condition), Hello messages are preferably released very close together in time for a short period of time (for example, 5 times per second for 2 seconds).

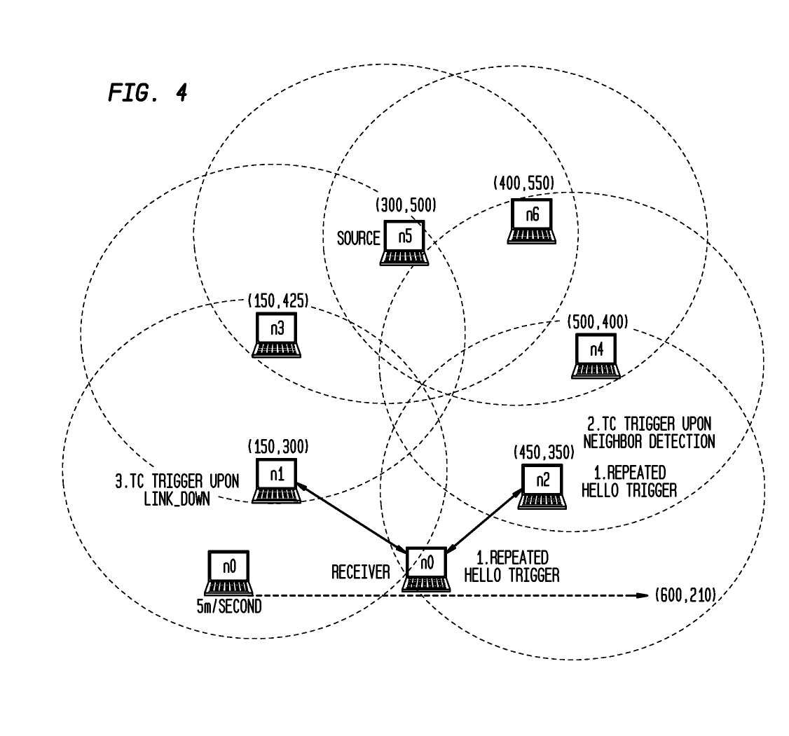

The second approach (“Approach 2”) (applied to a second network scenario (“Scenario 2”) shown in FIG. 4 as providing a two-hop and a three-hop possible path between a source node and a receiver node), provides the sequence of Hello trigger plus TC trigger. Scenario 2 considers a case of routing convergence for a routing path from a source to the destination, which requires routing update at the nodes on the path beyond the two-hop distance. In Scenario 2, when n0 moves to n2, a new routing path from n5 to n0 needs to be established by deleting the old path from n5 to n0 via n3 and n1, and updating the existing routing entries for n0 at n5, n6, n4, and n2. The interesting part of this routing convergence process is the routing update process at n5. When n0 is affiliating to n1, based on the TC message from n1, n5 recognizes that n0 is directly connected to n1 and is located a 3-hop distance away. Such topology information is stored in the topology control (“TC”) table. Note that in this OLSR implementation, nodes maintain a routing table, TC table, link table, and a neighboring table.

When n0 moves to n2 and once the new symmetric link between n0 and n2 is established, n2 floods the TC message through which the nodes including n5 on the network are informed that n2 has a direct connection to n0. This does not mean that n5 overwrites the TC information about n0 previously recorded through the TC message from n1. Instead, n5 keeps the TC information from both n1 and n2 as separate TC entries; n5 would consider as if n0 is connected to both n1 and n2. In this transition period, n5 has two routing paths for n0—one toward n1 and the other one toward n2. However, it selects the path toward n1 instead of n2 because the routing distance to n1 is one-hop shorter than that to n2.

Such a miscalculated routing causes packet loss, which will last until it receives an updated TC message from n1 advertising that n0 is no longer connected to n1. This updated TC message can be generated only when n1 confirms that the neighbor holding timer for n0 expires. In other words, if n1 has not received any “Hello” message from n0 during the predefined neighbor holding period (about 6 seconds in our simulation), n1 will no longer consider n0 as its neighbor, and will generate and advertise the updated TC message through the MPR-based efficient flooding.

In Approach 2 of the present invention, as applied by way of example and not limitation to Scenario 2 of FIG. 4, the MIH agent of a node interrupts the OLSR agent of the node when the MIH agent detects a new neighbor or Link_Going_Down event. Accordingly, for the scenario in FIG. 4, a sequence of three different triggers are invoked by the OLSR agents of n0, n1 and n2: repeated Hello trigger by n0 and n2 upon new neighbor determination, TC trigger by n2 upon new neighbor determination, and TC trigger by n1 upon Link_Down. The OLSR agent of n1 can detect promptly that the link between n1 and n0 is going-down and removes such a link without waiting for the neighbor holding expiration time, which typically is about 6 seconds. Once the link is deleted, n1 immediately (without waiting for the next periodic TC update time) advertises that n0 is no longer a neighbor of n1 through a TC message. Accordingly, the routing table of the source n5 is updated for the routing to n0. Consequently, the routing convergence time is significantly reduced for this particular scenario with traffic disruption of 0.3 seconds.

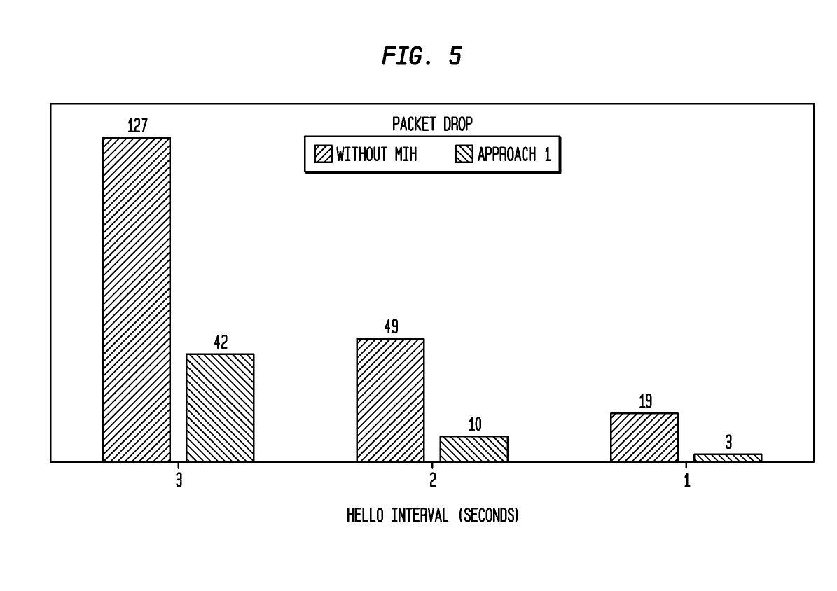

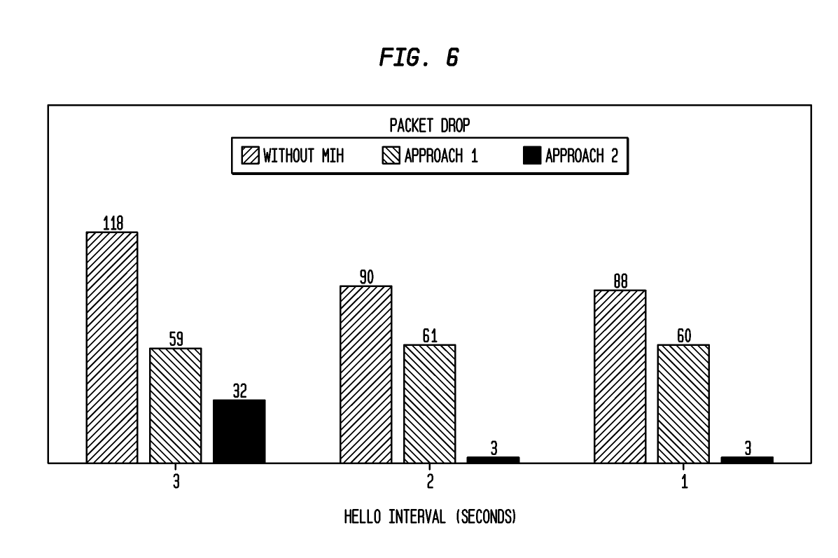

Through simulation, OLSR with MIH to trigger Hello messages outperforms the OLSR without MIH for all the different “Hello” intervals, as shown in FIG. 5. The number of dropped packets during handoff is significantly reduced by Approach 1 for network Scenario 1. As shown in FIG. 6, Approaches 1 again shows significant reduced packet loss, but also shows that Approach 2 can further reduce packet loss. Thus, combining Approach 1 and Approach 2 greatly reduce traffic disruption than the OLSR without MIH for Scenario 2.

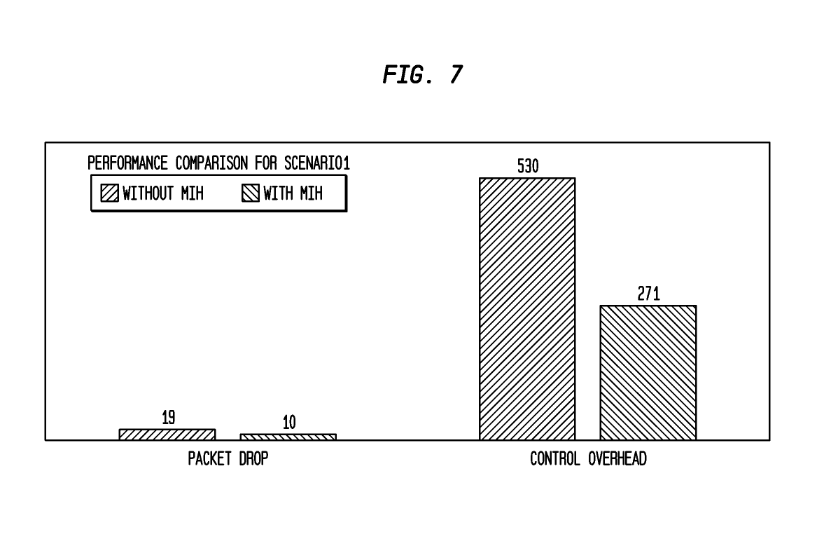

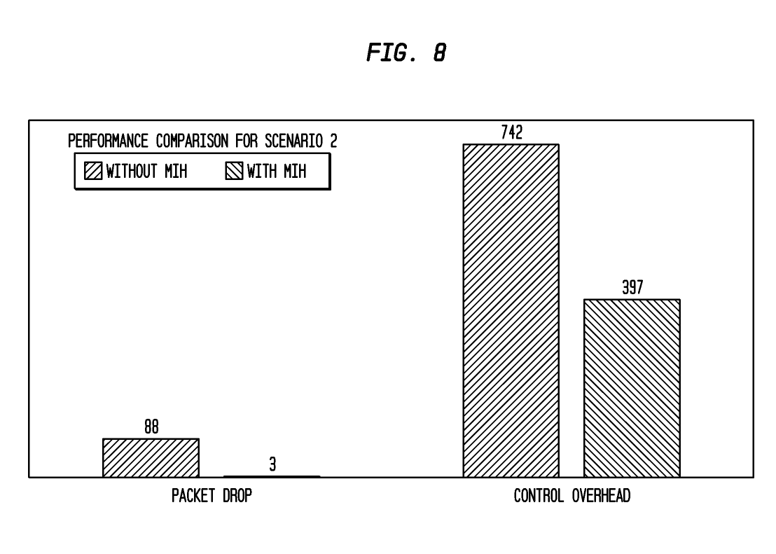

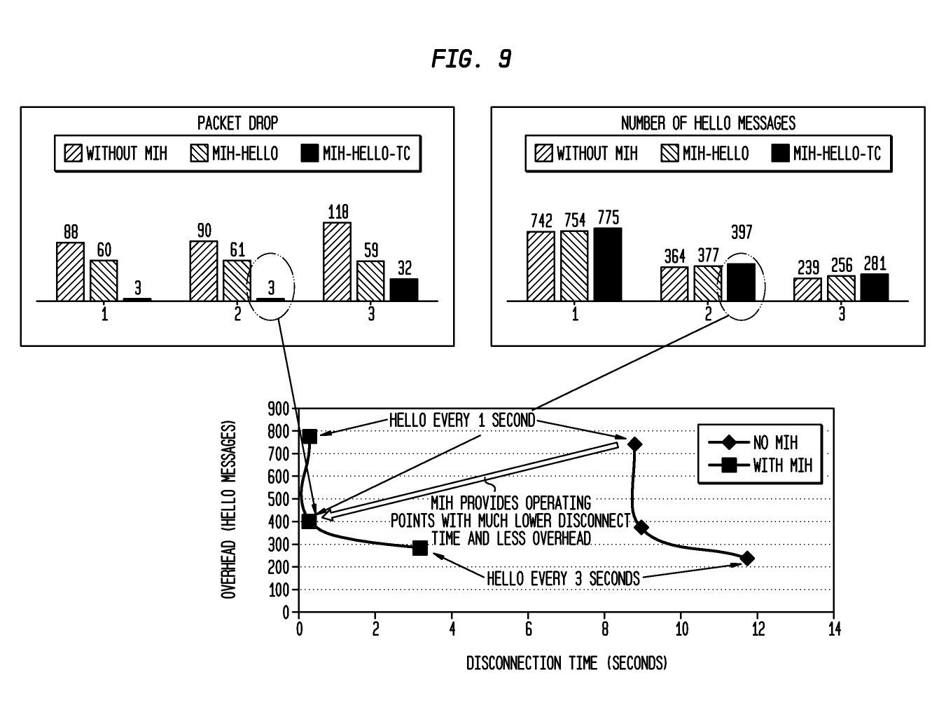

As shown in FIGS. 7 and 8, Approach 1 and 2 is shown to provide significant improvement on the performance of OLSR by reducing not only packet loss but also control overhead at the same time. For example, as shown in FIG. 8 for Scenario 2, packet loss due to mobility can be reduced by ˜97% with a constant bit rate (“CBR”) of 10 packets per second of traffic and the control overhead can simultaneously be reduced ˜50% by changing the “Hello” interval from 1 to 2 seconds. FIG. 9 summarized the simultaneous gains from employing Approach 1 and Approach 2. The graph shows that the use of MIHF interrupted-trigger method can allow both significant reduction in disconnection time and reduced overhead. The fundamentally shifts the tradeoff between overhead and disconnection time for an ad-hoc routing protocol in an ad-hoc network environment, which is one of the key factors for deriving a scalable, reliable, and efficient ad-hoc network.

Thus, simulations were conducted for the mobility scenarios as described above. For each case, performances of both OLSR without MIHF and OLSR with MIHF over different “Hello” intervals were evaluated. They were compared in terms of packet loss and control overhead. The table below shows operational parameters for the simulations.

TABLE 1
Operational Parameters for Simulations

| | | |
|---|---|---|
| Simulation duration | 100 | seconds |
| User Datagram Protocol | 10 to 70 | seconds |
| (“UDP”) application duration | | |
| OLSR Hello intervals | 3, 2, and 1 | seconds |
| TC interval | 3 | seconds |
| Neighbor holding expiration | 6 | seconds |
| Data packet size | 1000 | bytes |
| Data rate (CBR) | 10 | packets/second |
| Speed of a mobile node | 5 | m/second |

The present invention thus increases performance and efficiency in ad-hoc network environments. In order to capture the value of MIH, according to the present invention, OLSR is used with one of the proactive ad-hoc routing protocols, such as an MIH user. To enable OLSR as an MIH user, the link detection mechanism of MIHF for ad-hoc network environments is enhanced; next, an interface is implemented between OLSR and MIH protocols through which an MIH event is delivered to the OLSR protocol; and finally, functions are implemented on the OLSR protocol that handle the event from MIH.

Two ad-hoc network scenarios are disclosed, which can manifest the typical routing behaviors of OLSR, and both are analyzed in the aspect of routing convergence. Based on the analysis of the OLSR routing behaviors, two approaches are provided to improve routing convergence of OLSR through MIH: MIH-driven “Hello” triggers and MIH-driven “Hello plus TC” triggers.

Simulations are provided for Scenarios 1 and 2 with Approaches 1 and 2, and compared with the OLSR without MIH. According to the outcome of the simulations, Approach 1 improved the performance of OLSR by reducing routing convergence time for the network scenario that requires a routing update within 2 hops. By itself, however, this is not as effective in a network scenario that requires a routing update beyond 2 hops. On the other hand, Approach 2 improved the performance of OLSR for the network scenario that requires a routing update beyond 2 hops. Overall, the performance of OLSR was significantly improved through the integration of MIH.

The foregoing description has been presented for purposes of illustration. It is not exhaustive and does not limit the invention to the precise forms or embodiments disclosed. Modifications and adaptations of the invention can be made from consideration of the specification and practice of the disclosed embodiments of the invention. For example, one or more steps of methods described above may be performed in a different order or concurrently and still achieve desirable results.

Other embodiments of the invention will be apparent to those skilled in the art from consideration of the specification and practice of the invention disclosed herein. It is intended that the specification and examples be considered as exemplary only, with a true scope of the invention being indicated by the following claims.

1. A method comprising:
identifying, by a computing device in a network, at least one of a new neighbor or a link loss in the network; and
using, by the computing device, a media independent handover (MIH) agent to interrupt a routing protocol agent in the network in response to identifying at least one of the new neighbor or the link loss in the network.

2. A method comprising:
identifying, by a computing device in a network, at least one of a new neighbor node or a link loss; and
triggering, b the computing topology dissemination messages in response to identifying at least one of the new neighbor node or the link loss.

3. The method of claim 2, further comprising determining a strength of received radio signals between nodes in the network to identify the new neighbor node, wherein the triggering of topology dissemination messages is based at least in part on the determination of the strength of the received radio signals.

4. The method of claim 2, further comprising determining a strength of received radio signals between nodes to identify the link loss, wherein the triggering of topology dissemination messages is based at least in part on the determination of the strength of the received radio signals.

5. The method of claim 2, wherein the topology dissemination messages are executed using at least one of hello or topographical control (TC) messages as a part of an optimized link state routing (OLSR) protocol.

6. The method of claim 3, wherein the determination of the strength of the received radio signals is based on one or more physical layer parameters.

7. The method of claim 6, wherein the one or more physical layer parameters include at least one of a radio model, a radio frequency, a transmitting power, or a distance between sending and receiving nodes.

8. The method of claim 5, wherein an identification of at least one of the new neighbor or the link loss is communicated to the OLSR by a media independent handover function (MIHF).

9. The method of claim 2, wherein triggering comprises triggering of a hello message in response to identification of the new neighbor node and a topographical control (TC) message based on identification of the link loss.

10. A method of comprising:
performing at least one of a new neighbor determination and a link loss determination in a mobile re-routing system; and
triggering a message in response to at least one of the new neighbor determination or the link loss determination, wherein the message is a hello message used to identify one or more new neighboring nodes in response the new neighbor determination, and wherein the message is a topographical control (TC) message used for routing convergence in response to the new link loss determination.

11. The method of claim 10, further comprising determining a strength of received radio signals between nodes, and wherein the message is based at least in part on the determination of the strength of the received radio signals between nodes.

12. The method of claim 10, wherein the triggering is of the TC message based on the new neighbor determination.

13. The method of claim 10, wherein the hello message and the TC message are executed as a part of an optimized link state routing (OLSR) protocol.

14. The method of claim 11, wherein said determination of the strength of the received radio signals is determined based on one or more physical layer parameters.

15. The method of claim 14, wherein the one or more physical layer parameters include at least one of a radio model, a radio frequency, a transmitting power, or a distance between sending and receiving nodes.

16. The method of claim 13, wherein at least one of the new neighbor determination or the link loss determinations is communicated to the OLSR by a media independent handover function (MIHF).

17. The method of claim 10, wherein the triggering is of both the hello message based on the new neighbor determination and the TC message based on the link loss determination.

18. A system comprising:
a memory configured to store a media independent handover (MIH) agent; and
a processor operatively coupled to the memory and configured to:
identify, in a network, at least one of a new neighbor or a link loss; and
use the MIH agent to interrupt a routing protocol agent in the network in response to at least one of the new neighbor or the link loss.

19. The system of claim 18, wherein the processor is further configured to determine a strength of received radio signals between nodes to identify the link loss.

20. The system of claim 18, wherein the processor is further configured to determine a strength of received radio signals between nodes to identify the new neighbor.

21. A system comprising:
a memory; and
a processor operatively coupled to the memory and configured to:
identify, in a network, at least one of a new neighbor or a link loss; and
trigger one or more topology dissemination messages based on at least one of the new neighbor or the link loss.

22. The system of claim 21, wherein the topology dissemination messages are executed using at least one of hello or topographical control (TC) messages as a part of an optimized link state routing (OLSR) protocol.

23. The system of claim 21, wherein an identification of at least one of the new neighbor or the link loss is communicated to the OLSR by a media independent handover function (MIHF).

24. The system of claim 21, wherein the one or more topology dissemination messages comprise both the hello message based on identification of the new neighbor and the TC message based on identification of the link loss.
